(19) United States
(12) Patent Application Publication
(10) Pub. No.: US 2015/0232070 A1
(43) Pub. Date: Aug. 20, 2015

(54) PARK LOCK FOR DRIVE MODULE

(71) Applicant: e-AAM Driveline Systems AB

(72) Inventor: Erik J. Sten, Trollhattan (SE)

(73) Assignee: e-AAM Driveline Systems AB

(21) Appl. No.: 14/180,412

(22) Filed: Feb. 14, 2014

(51) Int. Cl. B60T 1/06; B60W 10/10; B60W 10/08

(52) U.S. Cl. CPC B60T 1/062; B60W 10/08; B60W 10/10

(57) ABSTRACT

A drive module with a motor, a transmission and differential assembly and a park lock. The transmission and differential assembly is driven by the output shaft of the motor. The transmission and differential assembly is operable in at least one mode for driving at least one of a first output member, a second output member and the differential case. The park lock includes a plunger that is movable between a first position and a second position. The drive module can be operated in a first mode such that the plunger is in the first position and inhibits rotation of the rotor relative to the stator to thus inhibit rotation of the first and second output members. The drive module can also be operated in a second mode such that the plunger is in the second position and does not inhibit rotation of the rotor relative to the stator so that it does not inhibit rotation of the first and second output members.

### FIELD

The present disclosure relates to a park lock for a drive module.

### BACKGROUND

Drive modules for providing primary or auxiliary propulsive power for driving a set of vehicle wheels are known in the art. One example of such a drive module is disclosed in U.S. Patent Application Publication No. 2012/0058855. When such drive modules are employed to provide auxiliary propulsive power for intermittently driving a set of vehicle wheels, it may be permissible to rely on a park lock that is associated with the driveline that drives a set of permanently driven vehicle wheels, depending on various governmental and vehicle OEM requirements. When such drive modules are employed to provide primary propulsive power, various governmental and vehicle OEM requirements may dictate that the drive module incorporate a park lock to lock the set of wheels that is driven by the drive module.

Park locks typically employ linkages for pivoting a spring-loaded pawl into engagement with a gear to lock a portion of a driveline so that a set of the vehicle wheels are permitted to rotate by only a very small amount. Such park locks can be relatively complicated and may have a configuration that cannot be used across a wide range of drive modules. Accordingly, while such drive modules are suited for their intended purpose, there remains a need in the art for a drive module with an improved park lock.

### SUMMARY

This section provides a general summary of the disclosure, and is not a comprehensive disclosure of its full scope or all of its features.

In one form, the present teachings provide a drive module that includes a motor, a transmission and differential assembly and a park lock. The motor has a stator and a rotor with an output shaft. The transmission and differential assembly is driven by the output shaft and has a transmission assembly and a differential assembly. The differential assembly has a differential case, a first differential output and a second differential output. The transmission and differential assembly is operable in at least one mode for driving at least one of the first output member, the second output member and the differential case. The park lock includes a plunger that is movable between a first position and a second position. When the plunger is in the first position the plunger inhibits rotation of the rotor relative to the stator. When the plunger is in the second position, the plunger does not inhibit rotation of the rotor relative to the stator.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an exemplary vehicle having a drive module constructed in accordance with the teachings of the present disclosure;

FIG. 2 is a schematic illustration of the drive module shown in FIG. 1;

FIG. 3 is a schematic illustration of a portion of the drive module shown in FIG. 1, illustrating a park lock in more detail; and

FIG. 4 is a perspective view of a portion of the drive module shown in FIG. 1 illustrating the park lock in more detail.

Corresponding reference numerals indicate corresponding parts throughout the several views of the drawings.

### DETAILED DESCRIPTION

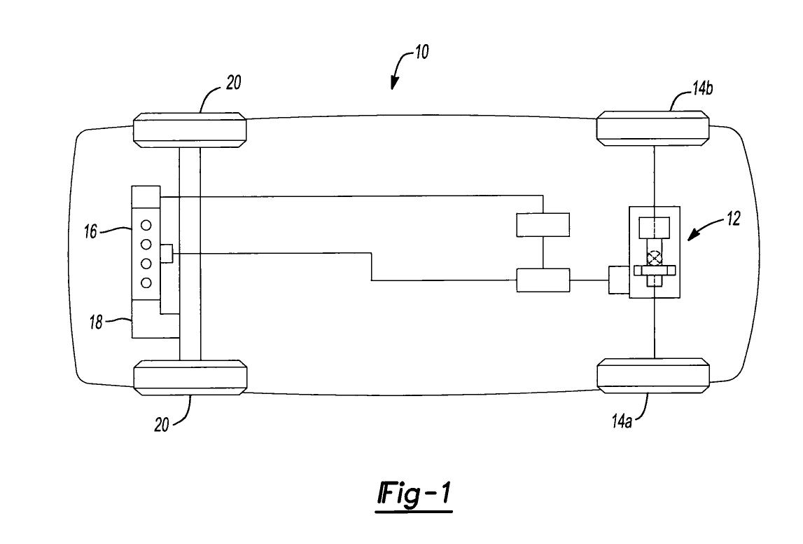

With reference to FIG. 1 of the drawings, an exemplary vehicle 10 is illustrated as having a drive module 12 that is constructed in accordance with the teachings of the present disclosure. The drive module 12 can be employed to drive a pair of vehicle wheels 14a and 14b. In the particular example provided, the drive module 12 is employed to selectively drive the rear vehicle wheels 14a and 14b (i.e., the drive module can be part of a secondary driveline that is operated on a part-time basis), while a conventional internal combustion engine 16 and transmission 18 are employed to drive a set of front vehicle wheels 20 on a full-time basis. It will be appreciated, however, that the teachings of the present disclosure have application to various vehicle configurations and as such, it will be understood that the particular example discussed herein and illustrated in the appended drawings is merely exemplary.

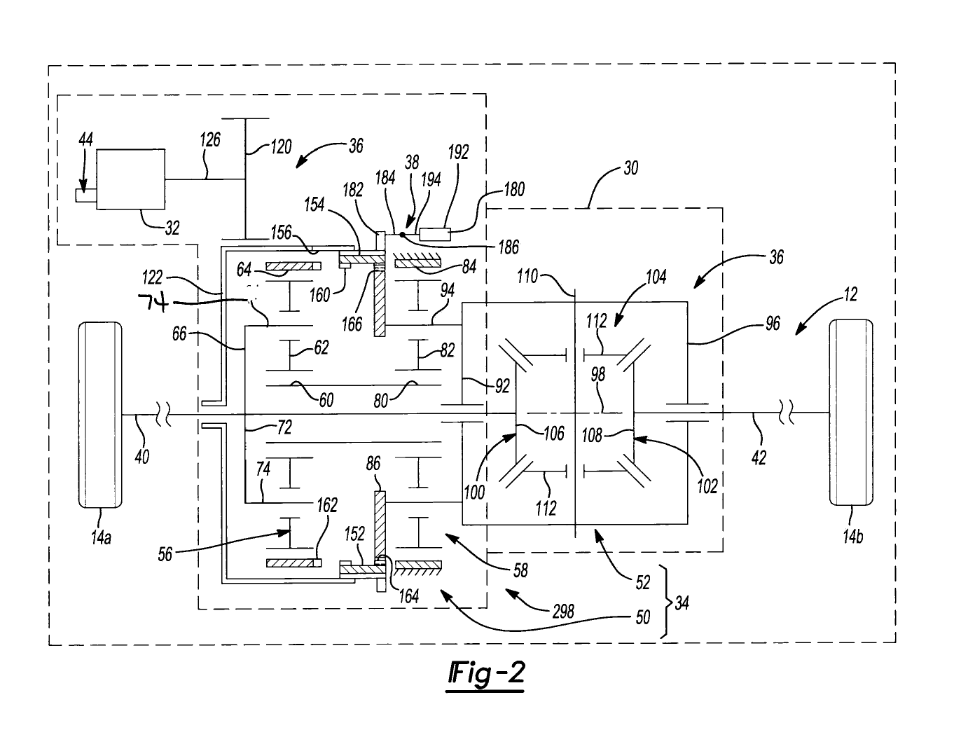

In FIG. 2, the drive module 12 can include a housing 30, a motor 32, a transmission and differential assembly 34, a reduction drive 36, a mode actuator 38, first and second output members 40 and 42, and a park lock 44. The housing 30 can be configured to house the motor 32 and the transmission and differential assembly 34.

The motor 32 can be any type of device for providing rotary power, such as an electric motor or a hydraulic motor. The motor 32 can be configured to drive the transmission and differential assembly 34 in one or more modes, such as a propulsion mode and/or a torque vectoring mode.

The transmission and differential assembly 34 can be configured to output rotary power to the first and second output members 40 and 42 and can include a transmission assembly 50 and a differential assembly 52. The first and second output members 40 and 42 can transmit rotary power from the transmission and differential assembly 34 to the rear vehicle wheels 14a and 14b, respectively.

The transmission assembly 50 can be co-axially mounted with respect to the first and second output members 40 and 42 and/or a differential assembly 52. The transmission assembly 50 can comprise a first planetary gear set 56 and a second planetary gear set 58. The first and second planetary gear sets 56 and 58 can have identical gear ratios and can be configured such that one or more of the components of the first planetary gear set 56 is/are interchangeable with associated component(s) of the second planetary gear set 58.

The first planetary gear set 56 can comprise a first sun gear 60, a plurality of first planet gears 62, a first ring gear 64, and a first planet carrier 66. The first sun gear 60 can be a generally hollow structure that can be mounted concentrically about the first output member 40. The first planet gears 62 can be spaced circumferentially about the first sun gear 60 such that teeth of the first planet gears 62 meshingly engage teeth of the first sun gear 60. Likewise, the first ring gear 64 can be disposed concentrically about the first planet gears 62 such that the teeth of the first planet gears 62 meshingly engage teeth on the first ring gear 64. The first ring gear 64 can be rotatably disposed in the transmission housing 30. The transmission housing 30 can be non-rotatably coupled to the differential housing 30, which houses the differential assembly 52. The first planet carrier 66 can include a first carrier body 72 and a plurality of first pins 74 that can be fixedly coupled to the first carrier body 72. The first carrier body 72 can be coupled to the first output member 40 such that the first carrier body 72 and the first output member 40 co-rotate. Any suitable means may be employed to couple the first carrier body 72 to the first output member 40, including welds and mating teeth or splines. Each of the first pins 74 can be received into an associated one of the first planet gears 62 and can support the associated one of the first planet gears 62 for rotation about a longitudinal axis of the first pin 74.

The second planetary gear set 58 can comprise a second sun gear 80, a plurality of second planet gears 82, a second ring gear 84, and a second planet carrier 86. The second sun gear 80 can be a generally hollow structure that can be mounted concentrically about the first output member 40. The second sun gear 80 can be non-rotatably coupled to the first sun gear 60 (e.g., the first and second sun gears 60 and 80 can be integrally and unitarily formed). The second planet gears 82 can be spaced circumferentially about the second sun gear 80 such that the teeth on the second planet gears 82 meshingly engage teeth of the second sun gear 80. The second ring gear 84 can be disposed concentrically about the second planet gears 82 such that the teeth of the second planet gears 82 meshingly engage teeth on the second ring gear 84. The second ring gear 84 can be non-rotatably coupled to the transmission housing 30. The second planet carrier 86 can include a second carrier body 92 and a plurality of second pins 94 that can be fixedly coupled to the second carrier body 92. The second carrier body 92 can be coupled to a differential housing or case 96 of the differential assembly 52 such that the second carrier body 92 and the differential case 96 co-rotate. Each of the second pins 94 can be received into an associated one of the second planet gears 82 and can support the associated one of the second planet gears 82 for rotation about a longitudinal axis of the second pin 94.

The first and second planetary gear sets 56 and 58 can be co-aligned about a common longitudinal axis 98 (i.e., an axis that can extend through the first and second sun gears 60 and 80) and can be offset from one another axially along the common longitudinal axis 98.

In addition to the differential case 96, the differential assembly 52 can include a means for transmitting rotary power from the differential case 96 to the first and second output members 40 and 42. The rotary power transmitting means can include a first differential output 100 and a second differential output 102. In the particular example provided, the rotary power transmitting means comprises a differential gear set 104 that is housed in the differential case 96 and which has a first side gear 106, a second side gear 108, a cross-pin 110 and a plurality of pinion gears 112. The first and second side gears 106 and 108 can be rotatably disposed about a rotational axis 98 of the differential case 96 and can comprise the first and second differential outputs 100 and 102, respectively. The first output member 40 can be coupled to the first side gear 106 for common rotation, while the second output member 42 can be coupled to the second side gear 108 for common rotation. The cross-pin 110 can be mounted to the differential case 96 generally perpendicular to the rotational axis 98 of the differential case 96. The pinion gears 112 can be rotatably mounted on the cross-pin 110 and meshingly engaged with the first and second side gears 106 and 108.

While the differential assembly 52 has been illustrated as employing bevel pinions and side gears, it will be appreciated that other types of differential mechanisms could be employed, including differential mechanisms that employ helical pinion and side gears or planetary gear sets. Furthermore, it will be appreciated that other means for transmitting rotary power from the differential case 96 to the first and second output members 40 and 42 may be employed in the alternative. For example, one or more clutches (e.g., friction clutches) may be employed to control transmission of rotary power to the first and second output members 40 and 42. As another example, a solid shaft may be employed in lieu of a mechanism that permits speed differentiation between the first and second output members 40 and 42.

The reduction drive 36 can be configured to transmit rotary power between the motor 32 and the first planetary gear set 56. The reduction drive 36 can include a reduction input member 120 and a reduction output member 122. If desired, various gears can be disposed between the reduction input and output members 120 and 122, but in the particular example provided, the reduction input member 120 is meshingly engaged to (and directly drives) the reduction output member 122. The reduction input member 120 can be a pinion that can be coupled to an output shaft 126 of the motor 32 for rotation therewith. The reduction output member 122 can be a ring gear that can be rotatably mounted about the first output member 40 and the first planetary gear set 56.

The mode actuator 38 can include a shift sleeve 152 that can input rotary power to the transmission assembly 50. The shift sleeve 152 can have a toothed exterior surface 154, which can be non-rotatably but axially slidably engaged to a matingly toothed interior surface 156 of the reduction output member 122, a set of first internal teeth 160, which can be selectively engaged to corresponding teeth 162 formed on the first ring gear 64, and a set of second internal teeth 164 that can be selectively engaged to corresponding teeth 166 formed on the second planet carrier 86.

The drive module 12 can be operated in a torque vectoring mode in which the shift sleeve 152 is positioned in a first position to couple the reduction output member 122 to the first ring gear 64 (via engagement of the set of first internal teeth 160 to the teeth 162 on the first ring gear 64) such that the reduction output member 122, the shift sleeve 152 and the first ring gear 64 co-rotate. It will be appreciated that the set of second internal teeth 164 are disengaged from the teeth 166 on the second planet carrier 86 when the shift sleeve 152 is in the first position.

When the motor 32 is activated (i.e., when the output shaft 126 of the motor 32 rotates in the example provided), the motor 32, the reduction drive 36 and the shift sleeve 152 can cooperate to apply rotary power to the first ring gear 64 of the first planetary gear set 56. The rotary power received by the first ring gear 64 is transmitted via the first planet gears 62 and the first planet carrier 66 to the first output member 40, while an opposite reaction is applied to the first sun gear 60 such that the first sun gear 60 rotates in a direction that is opposite to the first planet carrier 66. Rotation of the first sun gear 60 causes corresponding rotation of the second sun gear 80 to thereby drive the second planet gears 82. Because the second ring gear 84 is rotationally fixed to the transmission housing 30, rotation of the second planet gears 82 causes rotation of the second planet carrier 86 in a direction that is opposite to the direction of rotation of the first planet carrier 66. Accordingly, the magnitude of the rotary power (i.e., torque) that is transmitted from the second planet carrier 86 to the differential case 96 (and through the differential assembly 52 to the second output member 42) is equal but opposite to the magnitude of the rotary power (i.e., torque) that is transmitted from the first planet carrier 66 to the first output member 40.

Thus, as a result, the torque induced by the motor 32 to the first and second output members 40 and 42, respectively, is counter-directed. Moreover, since the first and second planetary gear sets 56 and 58 are operably coupled via the differential assembly 52, the magnitude of the induced torque at the first and second output members 40 and 42 is substantially equal. For example, if a positively directed torque is transmitted to the first output member 40 (via rotation of the output shaft 126 of the motor 32 in a first rotational direction), an equal negative torque is transmitted to the second output member 42. Similarly, if a negatively directed torque is transmitted to the first output member 40 (via rotation of the output shaft 126 of the motor 32 in a second rotational direction opposite the first rotational direction), an equal positive torque is transmitted to the second output member 42. In other words, the transmission and differential assembly 34 may be employed to generate a torque difference between the first and second differential outputs 100 and 102, which is communicated to the rear vehicle wheels 14a and 14b, respectively, through the first and second output members 40 and 42, respectively.

The drive module 12 can be operated in a drive mode in which the shift sleeve 152 is positioned in a second position to couple the reduction output member 122 to the second planet carrier 86 (via engagement of the set of second internal teeth 164 with the teeth 166 on the second planet carrier 86) such that rotary power provided by the motor 32 is input to differential case 96 and applied to the first and second output members 40 and 42 via the differential assembly 52. It will be appreciated that the set of first internal teeth 160 on the shift sleeve 152 can be disengaged from the teeth 162 on the first ring gear 64 when the shift sleeve 152 is in the second position. It will also be appreciated that rotary power provided by the motor 32 when the transmission and differential assembly 34 is operated in the drive mode is employed for propulsive power to propel (or aid in propelling) the vehicle 10 (FIG. 1).

In the neutral mode, the shift sleeve 152 can uncouple the reduction output member 122 from both the first ring gear 64 and the second planet carrier 86 such that the reduction output member 122 is decoupled from the first planetary gear set 56, the second planetary gear set 58, and the differential case 96. In the example provided, the shift sleeve 152 can be positioned in a third position between the first and second positions such that the sets of first and second internal teeth 160 and 164 are disposed axially between and disengaged from the teeth 162 on the first ring gear 64 and the teeth 166 on the second planet carrier 86. Accordingly, placement of the shift sleeve 152 in the third position decouples the motor 32 from the first planetary gear set 56, the second planetary gear set 58 and the differential case 96.

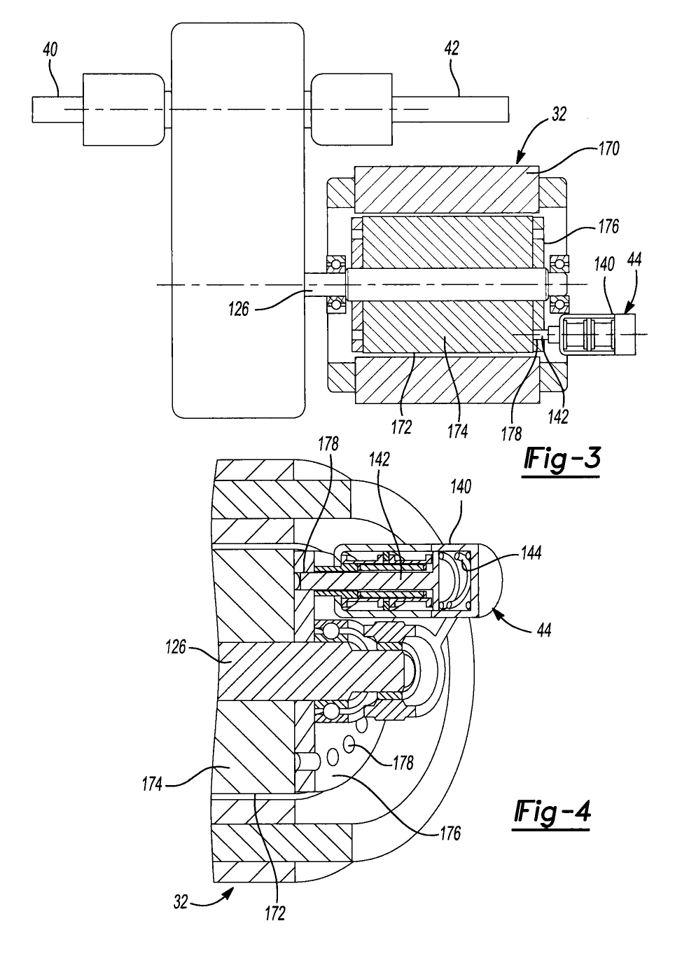

With reference to FIG. 3, the motor 32 can include a stator 170, a rotor 172, and an output shaft 126. The rotor 172 can include one or more lock apertures 178 being circumferentially spaced apart from one another. The rotor 172 can further include a rotor body 174 and a lock plate 176 fixed to the rotor body 174 to rotate therewith. In such a configuration, the one or more lock apertures 178 are located on the lock plate 176. The output shaft 126 drives the transmission and differential assembly 34. The park lock 44 can include a plunger 142 and a park lock body 140. The park lock body 140 can be fixed to the stator 170, the housing 30, or another surface static relative to the stator 170. The plunger 142 is movable relative to the park lock body 140 and can be moved between a first position and a second position. The plunger is configured to be received into the one or more lock apertures 178. In one exemplary embodiment, the plunger 144 is moved between the first position and the second position by a linear motor. The linear motor can be a solenoid, screw drive, hydraulic ram, cam and follower, or other type of linear motor.

When the plunger 142 is in the first position, the plunger 142 is received into the one or more lock apertures 178. When the transmission and differential assembly 34 is in the propulsion mode and the plunger 142 is in the first position, the plunger 142 inhibits rotation of the rotor 172 relative to the stator 170, thus inhibiting rotation of the output shaft 126 and the first and second differential outputs 100, 102. When the plunger 142 is in the second position, the plunger 142 does not inhibit the rotor 172 and the rotor 172 is free to rotate relative to the stator 170 to drive the output shaft 126 and the first and second differential outputs 100, 102. The park lock 44 can further include a biasing member 144, such as a spring, to bias the plunger 142 toward either the first or second position. As an example, using a solenoid with a biasing member 144 biasing the plunger 142 toward the first position would allow the drive module 12 to remain in a locked position when power is lost to the solenoid, whereas such a configuration with a bias toward the second position would allow the drive module 12 to remain in an unlocked position when power is lost to the solenoid. As a further example, using a screw drive to move the plunger 142 would allow the drive module 12 to remain in its current position of either locked or unlocked when power is lost.

In FIG. 4, one configuration of the drive module 12 of FIG. 1 is shown in greater detail. The rotor 172 is shown with the lock plate 176 fixed to the rotor body 174 and including a plurality of lock apertures 178. The park lock body 140 is shown fixed to the stator 170 with the plunger 142 in the first position and engaged with one of the lock apertures 178, thus inhibiting rotation of the rotor 172 and output shaft 126.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A drive module comprising:
first and second output members;
a motor having a stator and a rotor with an output shaft;
a transmission and differential assembly driven by the output shaft, the transmission and differential assembly having a transmission assembly and a differential assembly, the differential assembly having a differential case, a first differential output and a second differential output, the transmission and differential assembly being operable in at least one mode for driving at least one of the first output member, the second output member and the differential case; and
a park lock comprising a plunger that is movable between a first position and a second position, wherein when the plunger is in the first position the plunger inhibits rotation of the rotor relative to the stator, and wherein when the plunger is in the second position, the plunger does not inhibit rotation of the rotor relative to the stator.

2. The drive module of claim 1, wherein the park lock comprises a spring that biases the plunger toward one of the first and second positions.

3. The drive module of claim 1, wherein the plunger is received into a first lock aperture in the rotor when the plunger is in the first position.

4. The drive module of claim 3, wherein the first lock aperture is one of a plurality of lock apertures that are formed in the rotor, the lock apertures being circumferentially spaced apart from one another.

5. The drive module of claim 3, wherein the rotor comprises a rotor body and a lock plate that is fixed to the rotor body for rotation therewith, and wherein the first lock aperture is formed in the lock plate.

6. The drive module of claim 1, further comprising a mode actuator having an element that is movable between a first shift position and a second shift position, wherein the drive module operates in a first mode when the element is in the first shift position, wherein the drive module operates in a second, different mode when the element is in the second shift position, and wherein the element is disposed in the first shift position when the plunger is in the first position.

7. The drive module of claim 6, wherein the element is movable in an axial direction along a rotational axis of the differential assembly.

8. The drive module of claim 1, wherein the plunger is moved between the first position and the second position by a linear motor.

9. The drive module of claim 1, wherein the linear motor is a solenoid.

10. A method of locking a drive module, the method comprising:
providing a drive module with a housing, a motor, a transmission and differential assembly, and a park lock, the housing being configured to house the motor and transmission and differential assembly, the motor having a stator and a rotor with an output shaft, the output shaft being configured to drive the transmission and differential assembly, the transmission and differential assembly having a transmission assembly and a differential assembly, the differential assembly having a differential case, a first differential output and a second differential output, the park lock having a park lock body and a plunger, the park lock body being fixed to the stator or to the housing, the plunger being movably coupled to the park lock body;
moving the plunger from a first position toward a second position such that the plunger inhibits rotation of the rotor relative to the stator to thereby inhibit rotation of the first and second differential outputs; and
moving the plunger toward the first position such that the plunger does not inhibit the rotation of the rotor relative to the stator, thus not inhibiting rotation of the first and second differential outputs.

11. The method of claim 10, wherein the rotor or a structure coupled to the rotor defines a lock aperture and wherein the plunger is received in the lock aperture when the plunger inhibits rotation of the rotor relative to the stator.

12. The method of claim 10, further comprising biasing the plunger toward one of the first and second positions.
